(19) United States
(12) Patent Application Publication
(10) Pub. No.: US 2022/0095592 A1
(43) Pub. Date: Mar. 31, 2022

(54) Controlled Pan Feeder for Distribution of Livestock Feed

(71) Applicant: CTB, Inc., Milford, IN (US)

(72) Inventor: Wayne R. Mark, Elkhart, IN (US)

(21) Appl. No.: 17/477,489

(22) Filed: Sep. 16, 2021

Related U.S. Application Data
(60) Provisional application No. 63/079,272, filed on Sep. 16, 2020.

(51) Int. Cl. A01K 39/012; A01K 5/02

(52) U.S. Cl. CPC A01K 39/0125; A01K 5/02

(57) ABSTRACT

The invention is a system and method for controlled distribution of livestock feed to a plurality feeders along a feed line in a livestock enclosure. In a preferred embodiment, the feed is conveyed in predetermined quantities from a receptacle through the feed line to the feeders connected to the feed line. The feeders preferably comprise a portion configured to receive a measured quantity of feed from an orifice in the feed line and allow the flow of feed through the feeder, a pan, and a damper member housed by the feeder and configured to controllably block the flow of feed through the feeder into the pan. The respective damper members of the feeders are preferably controlled by an actuation mechanism that, when actuated, simultaneously moves the damper members from the feed flow blocking position in the feeders to an open position, thereby allowing feed to flow into all respective pans of the plurality of feeders along the feed line simultaneously.

### CROSS REFERENCE TO RELATED APPLICATIONS

This application claims the priority benefit of U.S. Provisional Patent Application No. 63/079,272 filed in the United States Patent and Trademark Office on Sep. 16, 2020.

### FIELD OF THE INVENTION

The present invention generally relates to the field of feeder systems for feeding livestock. More particularly, the invention relates to devices and methods for feed distribution in a controlled pan feeder system used in conjunction with poultry feeder systems.

### BACKGROUND OF THE INVENTION

Automated feeding systems for poultry and like domestic animals have proven to be highly successful in modern animal husbandry operations. These systems can supply feed mixtures to a large poultry flock with minimum effort by the poultry grower. Both the amounts of feed delivered, and the proportions of feed ingredients can be regulated, thus permitting the flock to be inexpensively raised from chicks to mature, commercially valuable birds in a relatively short time.

Among the important parts of such automated feeding systems are the feeder assemblies. These assemblies receive feed flow from a feed conveyor, and are located on or near the poultry house floor to afford the birds ready access to the feed.

Some chickens, called “broiler breeders” are bred for their meat production. Immature broiler breeders are often called “pullets.” In the husbandry industry, it is important to manage the timing of physical and sexual development of pullets.

Feeding pullets has been a challenge in the industry. Control of their feeding during development is very important to their health and productivity as an egg laying hen. While broilers, roasters, and fryers can be allowed to eat with few restrictions since the idea is to have them gain weight as safely and quickly as possible, pullets must be fed in a more controlled manner. When pullets do not feed well, they suffer stress and that can have detrimental effects on their health and lifespan productivity. As such, the amount of feed that is provided is restricted to help control the bird's physical development. More specifically, feed restriction is required to slow the physical development of the chickens so that they reach physical maturity at the same time they reach sexual maturity, at roughly 19 weeks of age. To accomplish this, typically the birds are fed roughly half of the amount of feed they would eat if the feed were available ad lib. The genetics of birds compels them to want to eat constantly. Attempting to dispense this small amount of feed causes a problem for feeding systems that are designed to dispense a large amount of feed. A small amount of feed can only travel so far in the feeder system before all the feed has fallen out into the feeder pans. Therefore, only a small percentage of the feeder pans receive feed. This contrasts with the need to maximize feeder space so all birds can eat at the same time.

Another challenge relates to the fact that the feed drops sequentially into the feeder pans as the auger moves the feed down the feed tube. The birds can actually eat the feed faster than it travels down the feed tube, further reducing the number of feeder pans that contain feed. An additional problem is the hoppers for each feed line are sequentially filled by the fill system. As a result, whole lines must wait to distribute feed while the first hopper is being filled. Yet another problem is that the feed line will only run when the control pan allows it. Problems inherent to control pans cause delays in the feed line auger running, causing uneven distribution.

In the end, there are many ways that the actual amount of feeder space is reduced in practice. Skip-a-day feeding is a method used to increase the amount of feed put into the house during a feeding session. Basically, double the feed is dispensed one day and then no feed is dispensed the next day, so overall the amount of feed (over time) remains the same.

Pullets in a feed house compete for the feed that is provided. As such, the larger birds tend to exclude the smaller birds from the feed. Bird weight uniformity, a key performance indicator of potential fertility, is difficult to optimize when smaller birds are excluded from feed by larger birds. Disease challenge and stress is high in this environment. The prospect of every-day feeding, instead of providing feed every other day, means even less feed is distributed on a daily basis. Another issue with this competition is, with the birds being so frantic to get to the feed, if the feeders are not designed to prevent entrapment, the birds can climb into the feeders, become entrapped, and die. Obviously, a dead bird is the ultimate loss of fertility and must be avoided.

FIGS. 1 and 2 show a prior art pan feeder 10 that is used in an automated system for feeding birds. The pan feeder 10 shown in FIGS. 1 and 2 are fully described in United States Patent Publication No. 2018/0263221 (now U.S. patent Ser. No. 10/827,728), which is hereby incorporated herein by reference in its entirety.

Pan feeders such as the pan feeder 10 shown in FIGS. 1 and 2, are often used in automated feed systems, such as the feed system 40 shown in FIG. 3. As shown in FIG. 3, the system 40 provides that several pan feeders 10 (for simplicity, only three pan feeders are shown) are provided along a long tube 506 that extends a long distance across the pullet house. A feed bin 42 is loaded with feed, and an auger or similar conveyance means (not specifically shown) pushes feed through the long tube or trough or feed line 506 to the pan feeders 10.

The pan feeder 10 shown in FIGS. 1 and 2 provides several advantages. Specifically, the pan feeder 10 does not have a grill through which the birds must go through to get the feed. The fact that there is no grill effectively eliminates mortality and bird damage that could result from entrapment in the grill. Additionally, the pan feeder 10 is relatively inexpensive, provides for easy cleaning, and is designed such that manure tends to be kept out of the feed pan 200 at the bottom of the device.

All that being said, the pan feeder 10 when used in connection with a system, such as the system 40 shown in FIG. 3, does provide some disadvantages, especially when it comes to feeding pullets. Specifically, as the auger moves the feed along the long tube 506, the feed falls through holes in the long tube 506 into the pan feeders 10. If a small amount of feed is desired to drop into the pan feeders, the holes may be provided as being smaller which could cause “bridging,” wherein the system gets jammed because the feed gets stuck in the smaller holes.

Also, the system 40 shown in FIG. 3 provides that feed does not drop simultaneously into all the pan feeders 10 that are connected to the long tube 506. Instead, the feed drops into the pan feeders 10 sequentially, starting with the pan feeder 10 that is closest to the feed bin 42 (i.e., starting with the left-most pan feeder 10). As a result, the pullets tend to race to the pan feeders 10 at the beginning of the line and compete for the feed. Obviously, the larger birds have the advantage. As discussed above, bird weight uniformity is a key performance indicator of potential fertility. As such, providing a feed system where the larger birds have the advantage over smaller birds is not an ideal situation.

Instead of providing different sized holes for controlling the amount of feed that is released into a given pan feeder, some systems provide that a hanger is provided above each pan feeder and the hanger is adjustable to cause a portion of the long tube, and also the hole provided therein, to be rotated such that the hole is not aimed directly downward. The more directly downward a hole is aimed, the more feed that will fall through the hole as the auger pushes the feed past the hole. Unfortunately, this system requires the manual adjustment of a plurality of hangers, and also results (when the hole is not aimed directly downward) in the feed being dispensed more to one side of the pan feeder than the other.

### SUMMARY OF THE DISCLOSURE

An embodiment of the present invention comprises a poultry feeding system that comprises pan feeders which allows feed to be distributed throughout the entire house and then release feed simultaneously. Specifically, an embodiment of the present invention comprises a pan feeder that is configured to be opened and closed in a controlled manner. Not only is the timing of the release of feed controlled, but so is the amount of feed that gets released. The fact that the system provides feed to all the pan feeders simultaneously allows the birds to train to that fact, instead of every feeding day basically being a random act of finding a feeder with feed therein.

A preferred embodiment of the present invention comprises:
A feed system for controlled distribution of livestock feed in a livestock enclosure, the feed system comprising:
a feed receptacle;
a feed line having a length and being connected to the feed receptacle, wherein the feed line houses a conveyance means;
a plurality of feeders intermittently connected to the length of the feed line, each of the plurality of feeders comprising a cap member, a cone member comprising an upper cone segment, a damper member housed by the cone member, one or more biasing members connected to the damper member, and a feed pan; and
a damper actuation mechanism comprising a rod and a plurality of connectors, the rod being connected to each of the caps of each of the plurality feeders and each of the plurality of connectors being connected to at least one of the respective damper members;
wherein the feed system is configured to convey the livestock feed from the feed receptacle through the fine line and into the plurality of feeders at the respective cone members;
wherein the respective damper members are configured to move between open and closed positions; and
wherein when the respective damper members are in the closed position the respective damper members are configured to contact the respective upper cone segments of the respective feeders and prevent the feed from flowing through the respective cone members into the respective feed pans.

Another preferred embodiment of the present invention comprises:
a method for controlled distribution of livestock feed in a livestock enclosure, the method comprising the steps of:
providing feed in a receptacle;
providing a plurality of feeders along a feed line connected to the receptacle, wherein the feeders each comprise a cone member, a damper member housed by the cone member and connected to a damper actuation mechanism, and a pan;
conveying the feed along a length of the feed line to the plurality of feeders;
distributing the feed in desired quantities into the feeders at the cone members, wherein a flow of feed from the cone members into the pans is initially blocked by the damper members; and
actuating the damper actuation mechanism to simultaneously move the damper members and allow the feed to flow into each of the pans of the plurality of feeders simultaneously.

### BRIEF DESCRIPTION OF THE FIGURES

FIG. 1 shows a top perspective view of a prior art pan feeder.

FIG. 2 shows a side elevational view of the pan feeder shown in FIG. 1.

FIG. 3 shows a feed system employing the pan feeder shown in FIGS. 1 and 2, and which can also be used to employ a pan feeder which is in accordance with an embodiment of the present invention.

FIG. 4 is a side view of a pan feeder which is in accordance with an embodiment of the present invention, where the pan feeder is shown in the closed condition, wherein feed is prevented from being released.

FIG. 5 is a view much like FIG. 4, but where the pan feeder is shown in an open condition, wherein feed is released.

### DETAILED DESCRIPTION OF AN EMBODIMENT OF THE INVENTION

While the present invention may be susceptible to embodiment in different forms, there is described herein in detail, a specific embodiment with the understanding that the present disclosure is to be considered an exemplification of the principles of the invention, and is not intended to limit the invention to that described herein.

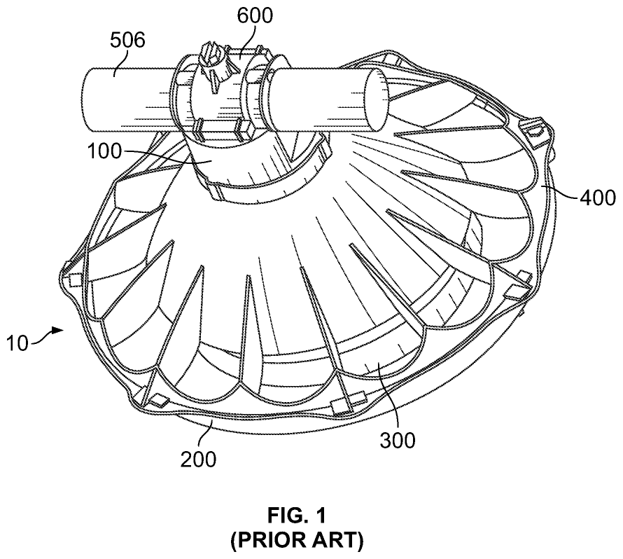

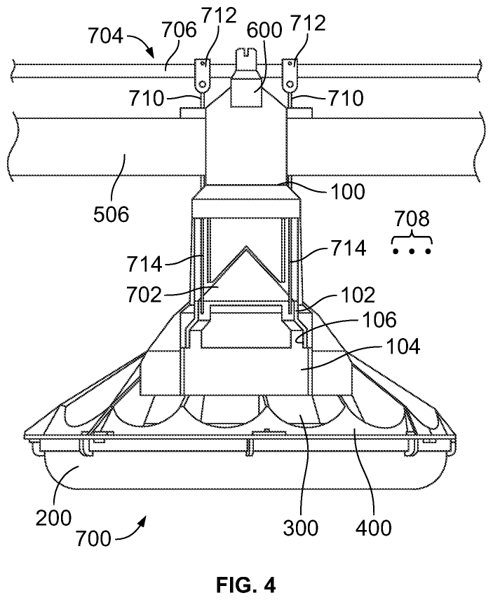

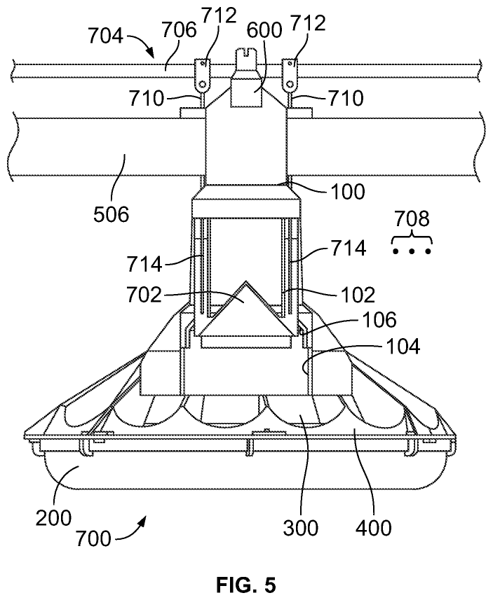

FIGS. 4 and 5 are views of a pan feeder 700 which is in accordance with an embodiment of the present invention. Preferably, the pan feeder 700 is similar to that which is described in United States Patent Publication No. 2018/0263221 (and shown as pan feeder 10 in FIGS. 1-3 herein), with the exception that the pan feeder 700 is configured to be controllably opened and closed, as will be described in more detail later hereinbelow.

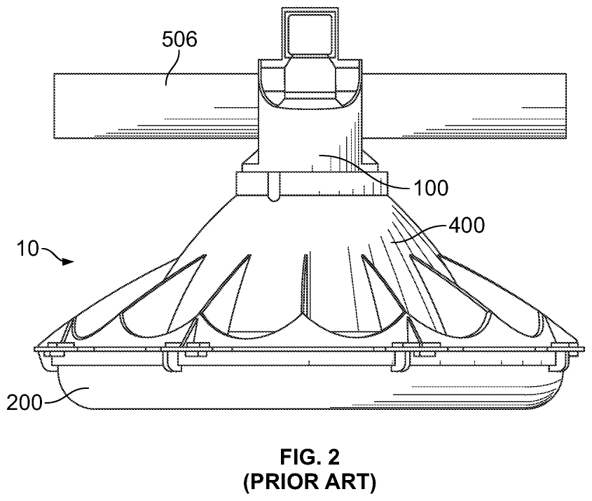

Much like the pan feeder 10 shown in FIGS. 1 and 2, preferably the pan feeder 700 is generally comprised of components such as a cone member 100, a feed pan 200, a skirt member 300, an excluder member 400, and a cap member 600. The various components are preferably comprised of heavy duty and durable polypropylene plastic materials, though other materials may be used as are known in the industry. Regardless of the exact construction and components, the pan feeder 700 is preferably in communication with a feed tube 506 (only a section of which is shown in FIGS. 4 and 5) which provides feed to the pan feeder 700.

It should be understood that although the term “cone” was used with reference to the cone member 100, the cone member 100 may not truly be of a geometric conical shape, but rather preferably has the general tapered configuration of a cone and is preferably of the preferred configuration and construction as shown and described herein.

As shown in FIGS. 4 and 5, the cone member 100 is preferably generally comprised of an upper cone segment 102 and a lower cone segment 104, and the upper cone segment 102 and lower cone segment 104 are preferably connected together and separated by a number of vertically disposed struts 106.

Preferably, each of the skirt member 300 and excluder member 400 includes an opening for slidably receiving the cone member 100. In an alternate embodiment, the skirt member 300 may be formed integrally with the cone member 100 and not be a separate component.

Although the pan feeder 700 of the present invention is preferably much like the pan feeder 10 shown and described in United States Patent Publication No. 2018/0263221 (and shown in FIGS. 1 and 2 herein), that is not imperative. An embodiment of the present invention provides a pan feeder 700 that can be opened and closed, and the structure and components of the pan feeder can take many different forms, forms that substantially differ from that which is described in United States Patent Publication No. 2018/0263221 while still staying within the scope of the present invention. Furthermore, while similar reference numerals have been used to identify similar components between pan feeders 10 and 700, it should be understood that the parts of pan feeder 700 (even those having identical reference numerals) may not be identical in size or shape to those of pan feeder 10 given that pan feeder 700 includes some components that are not included in pan feeder 10.

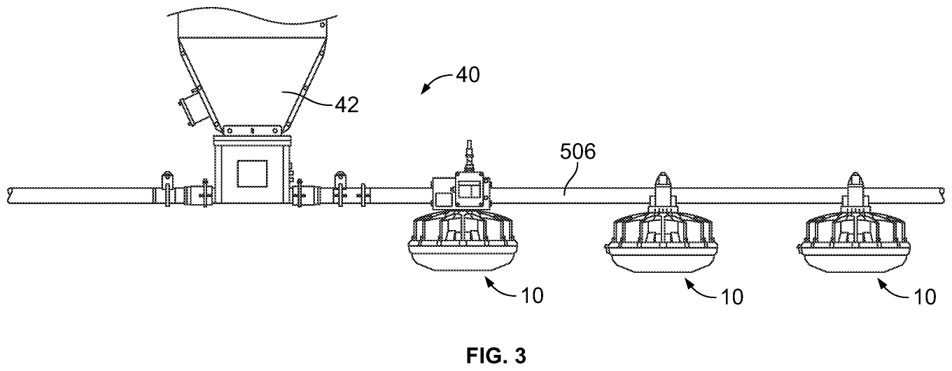

While FIG. 4 shows the pan feeder 700 in the closed condition, FIG. 5 shows the pan feeder 700 in an open condition. As shown, one way to achieve the ability to controllably open and close the pan feeder 700 is to provide a damper 702 on the inside of the pan feeder 700. Specifically, the damper 702 can be moved up and down in the pan feeder 700 to open and close the pan feeder 700 with regard to the delivering of feed to the feed pan 200. When the damper 702 is in the fully up position, such as shown in FIG. 4, feed is prevented from falling past the damper 702 into the feed pan 200 below. In contrast, when the damper 702 is lowered from the fully up position, such as shown in FIG. 5, feed is allowed to fall past the damper 702 into the feed pan 200 below. By employing a plurality of pan feeders 700 along a long tube 506 in a system, such as in the system 40 shown in FIG. 3, the dampers 702 of all the pan feeders 700 along the tube 506 can be controlled to release feed at the same time. Additionally, generally the same amount of feed can be released. When the dampers 702 open, all the feed in each pan feeder 700 drops out into the respective feed pan 200 below. As the birds in a feed house get more and more mature, they must eat more food. The system is configured to facilitate an increase in daily ration by cycling the filling/dumping process. In other words, the same amount of feed is dumped into the feed house more times per day as the birds get older/larger.

Preferably, the position of each of the dampers 702 is controlled by a damper actuation mechanism 704, which preferably comprises a torque device in the form of a rod 706 over the pan feeders 700, wherein the rod 706 rotates in one direction or the other, resulting in each of the dampers 702 of the pan feeders 700 either raising or lowering. While FIGS. 4 and 5 show a single pan feeder 700 connected to both the long tube 506 and the damper actuation mechanism 704, preferably a plurality of pan feeders 700 are connected to the long tube 506 and the damper actuation mechanism 704, as represented by dots 708. This provides that a plurality of pan feeders 700 can be controlled to simultaneously release generally the same amount of feed in a pullet house.

Preferably, the rod 706 is effectively connected to the dampers 702 via wound lift strings 710 which engage the damper 702, preferably one lift string or cord 710 connected to each end of the damper 702. Preferably, each lift string 710 is connected to a string clamp 712 which engages the rod 706. When the rod 706 is rotated in one direction, the lift strings 710 pull the damper 702 up into the closed position as shown in FIG. 4. Using a rod 706 and lift strings or connectors 710 provides an advantage of delivering the same level of actuation at each pan feeder 700, whereas cable actuation may not necessarily provide the same level of predictability due to, for example, stretching of the cable over long distances.

Preferably, the pan feeder also includes compression springs 714, preferably one spring 714 connected to each end of the damper 702, and the compression springs 714 function to push the damper 702 open when the rod 706 is rotated in the other direction (i.e., causing the lift strings 710 to unwind). Because the damper 702 can be pulled closed by the lift strings 710 or be pushed open by the compression springs 714, any level of opening of the damper 702 can be achieved by the amount that the lift strings 710 are wound. It is contemplated that alternative biasing members may be used in connection with or to replace springs 714.

In an alternative embodiment, a more rigid string, such as a cable, cord, or rod may be used to replace lift strings 710 and compression springs 714. In other words, a device with certain rigidity could provide force required in both directions as required for the opening and closing of the damper 702.

Regarding the upward (i.e., closed) position of the damper 702, preferably that is limited by the damper 702 contacting the upper cone segment 102, thereby effectively closing off the feed from dropping out the cone member 100, past the damper 702, into the feed pan 200. While the damper 702 is shown in FIGS. 4 and 5 as being a generally conical structure, the damper 702 can take many other shapes and sizes. Regarding the downward (i.e., open) position of the damper 702, that is determined by the amount of rotation of the torque rod 706. Between the closed and fully open position, the damper 702 can be opened to any extent depending on the extent that the lift strings 710 are wound.

Rotation of the torque rod 706 can be controlled using any suitable control system. Preferably, the extent to which the torque rod 706 is rotated (i.e., one way or the other) is precisely monitored by the control system, such as by using one or more limit switches. For example, one or more no contact limit switches can be employed, such as one or more Reed switches, to detect the angular position of the torque rod 706 and provide feedback to the control system wherein the feedback is used to either keep rotating the torque rod 706 in one direction or the other, or to stop rotation of the torque rod 706.

By having feed drop into the pan feeders 700 simultaneously, the birds have no motivation to rush to the pan feeders that are located closest to the feed bin 42. Additionally, feed does not tend to jam, such as in the smaller holes that are provided above certain pan feeders in an attempt to reduce the feed that is dispensed. The pan feeder 700 also provides that feed is not restricted to a small area in the pan (such as when feed is fed through holes that have been rotated out of a directly downward direction using hangers), thereby allowing the feed to be more evenly released into the feed pan 200, and allowing more feeder space to be available to the pullets.

The system disclosed herein provides that a small, controlled volume of feed can be provided simultaneously to all the pan feeders 700 in the feed house. The simultaneous feed drop maximizes the feed available at the start of the feeding time and removes the motivation of the birds to rush to the pan feeders 700 which are closest to the feed hopper 42. The system provides a consistency of feed availability.

While the present system of simultaneous feed to a plurality of pan feeders is novel, the system can be retrofit onto existing feed systems. Additionally, the system uses standard fill and control systems. As such, the feeding process remains familiar to the grower.

While the pan feeder 700 and feed system 40 has been described with regard to feeding pullets, the present invention is definitely not limited to that application and can, of course, by used to feed other livestock.

Another preferred embodiment of the invention is a method for distribution of feed in a livestock house. The method comprises the steps of: (i) providing feed in a receptacle, such as feed bin 42; (ii) providing a plurality of feeders 700 along a feed line 506, wherein the feeders 700 comprise a cone member 100, a pan 200, and a damper 702 preferably housed by the cone member 100 and connected to a damper actuation mechanism 704; (iii) conveying the feed along the feed line 506, such as by way of an auger in the feed line 506; (iv) distributing the feed conveyed in the feed line 506 in desired quantities into the feeders 700 at the cone members 100, wherein the immediate flow of feed into the pans 200 is blocked by the dampers 702; and (v) actuating the damper actuation system 704 to move the dampers 702 and allow the feed to flow into each feeder 700 along line 506 simultaneously.

While a specific embodiment of the invention has been shown and described, it is envisioned that those skilled in the art may devise various modifications without departing from the spirit and scope of the present invention.

1. A feed system for controlled distribution of livestock feed in a livestock enclosure, the feed system comprising:
a feed receptacle;
a feed line having a length and being connected to the feed receptacle, wherein the feed line houses a conveyance means;
a plurality of feeders intermittently connected to the length of the feed line, each of the plurality of feeders comprising a cap member, a cone member comprising an upper cone segment, a damper member housed by the cone member, one or more biasing members connected to the damper member, and a feed pan; and
a damper actuation mechanism comprising a rod and a plurality of connectors, the rod being connected to each of the caps of each of the plurality feeders and each of the plurality of connectors being connected to at least one of the respective damper members;
wherein the feed system is configured to convey the livestock feed from the feed receptacle through the fine line and into the plurality of feeders at the respective cone members;
wherein the respective damper members are configured to move between open and closed positions; and
wherein when the respective damper members are in the closed position the respective damper members are configured to contact the respective upper cone segments of the respective feeders and prevent the feed from flowing through the respective cone members into the respective feed pans.

2. The feed system of claim 1, wherein each of the respective damper members of the plurality of feeders are simultaneously in the closed position.

3. The feed system of claim 1, further comprising a control system configured to actuate the damper actuation mechanism.

4. The feed system of claim 3, wherein when the damper actuation mechanism is actuated, the respective one or more biasing members simultaneously push the respective damper member of each of the plurality of feeders from the closed position to the open position, wherein when the respective damper members are in the open position feed is allowed to flow through the respective cone members and into the respective feed pans of each of the plurality of feeders.

5. The feed system of claim 3, wherein when the damper actuation mechanism is actuated, the respective one or more biasing members compress, and the plurality of connectors simultaneously pull the respective damper members of each of the plurality of feeders from the open position to the closed position.

6. The feed system of claim 1, wherein the one or more biasing members are compression springs.

7. The feed system of claim 1, wherein the conveyance means is an auger.

8. A method for controlled distribution of livestock feed in a livestock enclosure, the method comprising the steps of:
providing feed in a receptacle;
providing a plurality of feeders along a feed line connected to the receptacle, wherein the feeders each comprise a cone member, a damper member housed by the cone member and connected to a damper actuation mechanism, and a pan;
conveying the feed along a length of the feed line to the plurality of feeders;
distributing the feed in desired quantities into the feeders at the cone members, wherein a flow of feed from the cone members into the pans is initially blocked by the damper members; and
actuating the damper actuation mechanism to simultaneously move the damper members and allow the feed to flow into each of the pans of the plurality of feeders simultaneously.
